(19) United States
(12) Patent Application Publication
(10) Pub. No.: US 2024/0190703 A1
(43) Pub. Date: Jun. 13, 2024

(54) PROCESS AND SYSTEM FOR PROVIDING PURIFIED HYDROGEN GAS

(71) Applicant: HYDROGENIOUS LOHC TECHNOLOGIES GMBH, Erlangen (DE)

(72) Inventors: Alexander WEIß, Möhrendorf (DE); Alexander SEIDEL, Erlangen (DE); Caspar PAETZ, Erlangen (DE); Holger BÜCH, Erlangen (DE); Daniel TEICHMANN, München (DE)

(21) Appl. No.: 18/555,072

(22) PCT Filed: Apr. 14, 2022
(86) PCT No.: PCT/EP2022/060061

§ 371 Date: Oct. 12, 2023

(30) Foreign Application Priority Data
Apr. 19, 2021 (DE) 10 2021 203 884.0

(51) Int. Cl. C01B 3/00

(52) U.S. Cl. CPC C01B 3/0015; C01B 2203/0227; C01B 2203/0261; C01B 2203/04; C01B 2203/065; C01B 2203/0844; C01B 2203/1041; C01B 2203/1252

(57) ABSTRACT

A method for providing hydrogen gas comprises a release of hydrogen gas in a dehydrogenation reactor by catalytic dehydrogenation of an at least partially charged hydrogen carrier medium to form an at least partially discharged hydrogen carrier medium, a catalytic oxidation of the at least partially discharged hydrogen carrier medium means of an oxidizing agent to form an at least partially oxidized hydrogen carrier medium in an oxidation reactor, a reduction of the at least partially oxidized hydrogen carrier medium to form the at least partially charged hydrogen carrier medium by catalytic hydrogenation in a hydrogenation reactor and a removal of at least one oxygen-containing impurity from the at least partially charged hydrogen carrier medium and/or from the at least partially oxidized hydrogen carrier medium.

### CROSS-REFERENCES TO RELATED APPLICATIONS

This application claims the priority of German Patent Application, Serial No. 10 2021 203 884.0, filed Apr. 19, 2021, the content of which is incorporated herein by reference in its entirety as if fully set forth herein.

### FIELD OF THE INVENTION

The invention relates to a method and a system for providing hydrogen gas.

### BACKGROUND OF THE INVENTION

It is known that hydrogen gas can be provided by catalytic dehydrogenation of a hydrogen carrier medium.

### SUMMARY OF THE INVENTION

It is an object of the invention to improve the provision of hydrogen, in particular by catalytic dehydrogenation of a hydrogen carrier medium, in particular to increase the economic efficiency of the hydrogen gas provision and/or the purity of the hydrogen gas provided.

This object is achieved according to the invention by a method for providing hydrogen gas comprising the method steps of
release of hydrogen gas in a dehydrogenation reactor by catalytic dehydrogenation of an at least partially charged hydrogen carrier medium to form an at least partially discharged hydrogen carrier medium,
catalytic oxidation of the at least partially discharged hydrogen carrier medium by means of an oxidizing agent to form an at least partially oxidized hydrogen carrier medium in an oxidation reactor,
reduction of the at least partially oxidized hydrogen carrier medium to form the at least partially charged hydrogen carrier medium by catalytic hydrogenation in a hydrogenation reactor,
removal of at least one oxygen-containing impurity from the at least partially charged hydrogen carrier medium and/or from the at least partially oxidized hydrogen carrier medium.

This object is further achieved by a system for providing hydrogen gas comprising
a dehydrogenation reactor for releasing hydrogen gas by catalytic dehydrogenation of an at least partially charged hydrogen carrier medium by means of a dehydrogenation catalyst into at least partially discharged hydrogen carrier medium,
an oxidation reactor for catalytically oxidizing the at least partially discharged hydrogen carrier medium by means of an oxidizing agent to an at least partially oxidized hydrogen carrier medium,
a hydrogenation reactor for reducing the at least partially oxidized hydrogen carrier medium to the at least partially charged hydrogen carrier medium by catalytic hydrogenation,
a purification unit for removing at least one oxygen-containing impurity from the at least partially charged hydrogen carrier medium and/or from the at least partially oxidized hydrogen carrier medium.

The essence of the invention is that at least partially discharged hydrogen carrier medium, from which hydrogen gas has been released by catalytic dehydrogenation of an at least partially charged hydrogen carrier medium, is oxidized by means of an oxidizing agent to form an at least partially oxidized hydrogen carrier medium. The exothermic oxidation reaction provides heat for the endothermic dehydrogenation reaction. An additional heat demand is thus reduced and in particular dispensable. The method is economical. Additionally, it has been found that oxygen-containing impurities are efficiently removed from the at least partially charged hydrogen carrier medium and/or from the at least partially oxidized hydrogen carrier medium. In particular, it has been found that the removal of oxygen-containing impurities from the at least partially charged hydrogen carrier medium and/or from the at least partially oxidized hydrogen carrier medium is more possible in a less complex and more efficient manner than removing oxygen-containing impurities from the released hydrogen gas. The overall purification effort is reduced. The overall efficiency for providing hydrogen gas with increased purity is reduced.

Oxygen-containing impurities are in particular oxygen-containing by-products, which can be formed in particular during dehydrogenation, such as carbon monoxide (CO), carbon dioxide (CO₂). Oxygen-containing impurities are also understood to mean oxidized degradation products and/or by-products of the hydrogen carrier medium from the oxidation reaction as well as at least partially oxidized hydrogen carrier medium from the oxidation reaction. Water, which may be present in particular as a liquid or in vapour form, may also be understood as an oxygen-containing impurity. Water can in particular be formed as a co-product during the reduction of the at least partially oxidized hydrogen carrier medium, i.e. during hydrogenation, and/or during the oxidation of the at least partially discharged hydrogen carrier medium.

It has been recognized that it is advantageous if the proportion of oxygen-containing impurities is minimized prior to the dehydrogenation reaction. Deactivation of a catalyst material used for the dehydrogenation reaction can be avoided. Undesirable oxygen-containing by-products, which would have to be purified from the gas phase at a later time at great expense, can be avoided.

Before the removal of the at least one oxygen-containing impurity, the water content may be between 1% by weight and 25% by weight depending on the method of proceeding during hydrogenation and/or oxidation. After the hydrogenation, the proportion of at least partially oxidized hydrogen carrier medium is low and is in particular at most 1%. After removal of the at least one oxygen-containing impurity and in particular prior to the dehydrogenation of the at least partially charged hydrogen carrier medium in the dehydrogenation reactor, the proportion of the at least one oxygen-containing impurity relative to the mass of all components in the fluid stream is in total at most 15%, in particular at most 12%, in particular at most 10%, in particular at most 8%, in particular at most 5%, in particular at most 3%, in particular at most 1%, in particular at most 0.5%, in particular at most 0.1% and in particular at most 0.01%.

It has proven to be particularly advantageous if the oxygen-containing impurities are removed from the at least partially charged hydrogen carrier medium, in particular after the hydrogen carrier medium has been at least partially charged in a hydrogenation reactor.

However, the removal of the oxygen-containing impurities can be carried out additionally or alternatively from the at least partially oxidized hydrogen carrier medium, in particular prior to a subsequent hydrogenation reaction in the hydrogenation reactor.

In particular, it has been recognized that it is advantageous for the overall efficiency of the method if already purified hydrogen carrier medium is provided for the dehydrogenation reaction. As a result of the fact that the oxygen-containing impurities have been at least partially removed from the liquid hydrogen carrier medium in a preceding purification step, the proportion of impurities in the released hydrogen gas can be efficiently reduced from the outset, i.e. decreased.

The hydrogenation takes place on a hydrogenation catalyst, in particular at a pressure level of 5 to 50 barg, in particular 10 to 40 barg and in particular 15 to 30 barg, as well as at a reaction temperature of 100 to 350° C., in particular 150 to 300° C. and in particular 200 to 270° C. The material for the hydrogenation catalyst is in particular platinum, palladium, ruthenium and/or rhodium. The catalyst material for the hydrogenation is applied in particular to an inert catalyst carrier. The inert material for the catalyst carrier can be aluminium oxide, silicon oxide, silicon carbide and/or activated carbon.

In the catalytic hydrogenation reaction, the at least partially oxidized hydrogen carrier medium Ox-LOHC is chemically converted to the at least partially charged hydrogen carrier medium Hx-LOHC to form a, in particular chemically, reduced and in particular oxygen-free compound with elimination of water. This elimination of water during the hydrogenation reaction represents a removal of an oxygen-containing impurity from the at least partially charged hydrogen carrier medium Hx-LOHC. This is an integrated purification step for the at least partially charged hydrogen carrier medium Hx-LOHC.

Additionally or alternatively, oxygen-containing impurities can be removed from the at least partially oxidized hydrogen carrier medium Ox-LOHC, in particular by using a stripping column and/or by means of selective adsorption.

It has been found that with the method according to the invention it is possible to provide hydrogen with increased purity. In particular, the purity of the released hydrogen gas, in particular after a final gas purification, is at least 99.0%, in particular at least 99.7% and in particular at least 99.999%. In particular, the gas purification serves to remove oxygen-containing impurities, wherein in particular less than 200 ppmV, in particular less than 100 ppmV, in particular less than 10 ppmV and in particular less than 1 ppmV are removed. The released hydrogen gas may still contain hydrocarbons as impurities, the proportion of which relative to the released hydrogen gas is less than 1000 ppmV, in particular less than 500 ppmV and in particular less than 200 ppmV. The released hydrogen gas can be transferred to a hydrogen gas consumer, in particular after gas purification. The hydrogen gas consumer is in particular a fuel cell.

An oxidation catalyst, which is arranged in particular in the oxidation reactor, serves to carry out the oxidation reaction. The oxidation catalyst has a catalytically active solid which comprises one or more metals, in particular vanadium, antimony, caesium, manganese, titanium, iron, cobalt, copper, platinum, palladium, ruthenium, cerium and/or nickel. Oxidation catalysts which comprise vanadium and in particular additionally antimony and/or caesium have proved to be particularly advantageous. The metal is in particular attached to a catalyst carrier which in particular comprises a porous carrier material. In particular, it has been found that titanium oxide and/or vanadium oxide can be used as an oxidation catalyst. A separate carrier material is not required in this case. The respective metal oxide may constitute the oxidation catalyst itself. The catalyst material is provided with a mass fraction relative to the material of the catalyst carrier of from 0.01% to 50%, in particular from 0.1% to 10% and in particular from 0.3% to 5%. The catalyst carrier material is in particular a metal oxide or a carbon-containing carrier material, in particular porous aluminium oxide, silicon oxide, titanium oxide, silicon carbide, cerium oxide or activated carbon. An oxidation catalyst composed of vanadium (V) oxide, antimony (III) oxide and caesium carbonate on titanium oxide has proven to be advantageous.

It has been found that the exotherm of the catalytic oxidation reaction can be used advantageously for the overall method. In particular, waste heat from the oxidation reaction can be made available for other method steps, in particular the dehydrogenation reaction. Chemically bound hydrogen which is bound to the at least partially discharged hydrogen carrier medium H0-LOHC can be efficiently oxidized to water by the oxidation reaction. Due to the at least partially incomplete dehydrogenation of Hx-LOHC in the dehydrogenation reactor to H0-LOHC, the hydrogen carrier medium is at least partially discharged, i.e. still has a certain amount of residual hydrogen. It has been found that this residual hydrogen can be advantageously oxidized and thus used to provide heat for the dehydrogenation reaction. In particular, a comparatively inefficient return transport of the at least partially discharged hydrogen carrier medium H0-LOHC is avoided.

By using the chemically bound residual hydrogen, the overall efficiency of the method is improved.

Additionally or alternatively, the conversion of at least one alkyl group and/or at least one alkylene group, in particular at least one methyl group and/or at least one methylene group, into a keto group, into an aldehyde group and/or into a carboxylic acid group may take place by oxidation in the oxidation reactor.

Additionally or alternatively, hydrogen gas can also be oxidized to water in the oxidation reactor. Hydrogen gas can be present in the fluid stream which is fed to the oxidation reactor, in particular in physically dissolved form. It is also possible that components of hydrogen gas that has already been released and not completely severed from the fluid stream are returned to the oxidation reactor as a result of recirculation. These residual components of the released hydrogen gas can also be oxidized to water in the oxidation reactor. In particular, the proportion of the physically dissolved and/or released hydrogen gas in the fluid stream which is fed to the oxidation reactor, and which in particular exclusively comprises the at least partially discharged hydrogen carrier medium and water gas, is at most 0.001% by weight relative to the mass of the fed fluid stream, in particular at most 0.02% by weight, in particular at most 0.05% by weight and in particular 0.01% by weight.

The oxidation reaction converts at most 5%, in particular at most 3% and in particular at most 1% of the carbon contained in the at least partially discharged hydrogen medium H0-LOHC to carbon dioxide (CO₂) and/or to carbon monoxide (CO).

A method comprising the transfer of heat generated in the oxidation reactor to the dehydrogenation reactor is particularly economical. It has been found that by means of the heat generated in the oxidation reactor, in particular at least 60% of the heat demand required for the dehydrogenation reaction can be provided. In particular, at least 70%, in particular at least 80%, in particular at least 90% and in particular at least 95% of the heat demand for the dehydrogenation reaction can be provided. In particular, all of the heat required for the dehydrogenation reaction can be provided. The additional effort for providing heat is reduced and in particular avoided.

The use of a dehydrogenation catalyst comprising a metallic catalyst material, in particular platinum, palladium, nickel, rhodium and/or ruthenium, which is in particular sulphidized, has proven to be particularly advantageous. In particular, it has been found that a dehydrogenation catalyst which comprises at least a proportion of sulphur has a particularly selective effect. Surprisingly, it has been found in particular that the selection of the dehydrogenation catalyst has a direct influence on the selectivity of the oxidation reaction and thus also on the purity of the hydrogen gas released. As a result, it is possible that significantly fewer by-products, in particular less large and/or less high-boiling by-products, in particular polycyclic hydrocarbon compound and/or other polymerization and/or condensation products, in particular polyaromatic hydrocarbons, and/or cleavage products such as toluene, xylene and/or benzene and/or their oxidized species such as benzophenones, benzoic acid, benzaldehyde and/or phthalic anhydride, are formed during the dehydrogenation reaction. As a result of the oxidation of the hydrogen carrier medium, high-boiling molecules can additionally or alternatively be formed as by-products, in particular if alkyl groups are not completely oxidized and cleaved as carbon monoxide (CO) and/or carbon dioxide (CO₂), but interact intermolecularly with other hydrogen carrier media. High-boiling molecules resulting from the oxidation of diphenylmethane and biphenyl are in particular fluorenones, xanthones and anthraquinones.

Selective dehydrogenation enables oxygen-containing impurities to be reduced, i.e. decreased, at an early stage in the method, and in particular to be prevented. The dehydrogenation catalyst comprises a metallic catalyst material to which sulphur has been added, i.e. which is sulphidized. In particular, it has been found that selective dehydrogenation is improved if the dehydrogenation catalyst has a metal/sulphur atomic ratio from 1:1 to 1:10, in particular from 1:1.5 to 1:5 and in particular from 1:1.5 to 1:2.5 and in particular from 1:2. The catalyst material is in particular arranged on a catalyst carrier and in particular attached thereto. The catalyst carrier is in particular aluminium oxide, silicon oxide, silicon carbide and/or activated carbon. The material of the catalyst carrier is in particular inert, i.e. does not participate in the dehydrogenation reaction. The proportion by weight of the catalyst material relative to the material of the catalyst carrier is in a range between 0.1% and 10%, in particular between 0.2% and 8%, in particular between 0.5% and 5%.

In particular, it has been found that the selectivity of the dehydrogenation reaction has a direct influence on the selectivity of the subsequent oxidation reaction of the at least partially discharged hydrogen carrier medium. The selective dehydrogenation by means of the dehydrogenation catalyst used is particularly efficient for the overall method. In particular, it has been found that polycyclic hydrocarbons cannot be selectively oxidized, since in particular the oxidation of methyl groups is less selective than the oxidation of methylene groups. Cleavage products, such as toluene and/or xylene, which can be formed in particular from benzyl toluene, increase the total number of methyl groups that are converted by cleavage of methylene groups.

A method, in which the catalytic oxidation comprises selectively oxidizing an alkyl functional group and/or an alkylene functional group of the at least partially discharged hydrogen carrier medium, reduces, i.e. decreases, the amount of undesirable substances by the catalytic oxidation reaction. In particular, it is possible to reduce, i.e. decrease, or avoid the formation of carboxylic acid functional groups, aldehyde groups and/or cyclic, high-boiling by-products. In addition, the formation of undesirable carbon monoxide (CO) and/or carbon dioxide (CO₂) is reduced.

In particular, the total proportion of by-products is at most 10% relative to the mass of all components of the fluid stream, in particular at most 5%, in particular at most 3% and in particular at most 1%. The proportion of carboxylic acid groups and/or aldehyde groups in the fluid stream is at most 5%, in particular at most 3% and in particular at most 1%. The mass fraction of the cyclic, high-boiling by-products in the fluid stream is at most 5%, in particular at most 3% and in particular at most 1%.

Oxidized cleavage products are in particular benzoic acid, benzaldehyde, tolylic acids and/or tolylualdehydes. High-boiling by-products are in particular smaller polycyclic hydrocarbon compounds such as naphthalene and/or anthracene and/or their oxidized form, in particular anthraquinones and/or xanthones. However, high-boiling by-products can also have larger hydrocarbon structures and contain up to 12 ring systems. Oxygen functional groups are reactive and may favour the formation of high boiling molecular structures, wherein aldehyde species are more reactive than ketones. It is also possible that carbon monoxide and carbon dioxide are formed as products of a complete oxidation of cleaved methyl groups.

Such components can be formed, for example, during the oxidation of methyl groups, which are present in particular in toluene and/or xylene. By selective oxidation during the catalytic oxidation reaction, the proportion of oxygen-containing impurities can be reduced overall, i.e. decreased, and amounts to a total of at most 10% relative to the mass of all components in the fluid stream, in particular at most 8%, in particular at most 5%, in particular at most 3%, in particular at most 2%, in particular at most 1%, in particular at most 0.5%, in particular at most 0.1% and in particular at most 0.01%. The values mentioned here refer to oxygen-containing impurities without water.

In particular, a phenyl group and/or its hydrogenated form, in particular as in benzyltoluene and/or dibenzyltoluene, serves as the residues of an alkyl group and/or an alkylene group. In particular, a methylene group can be arranged in a longer alkyl chain, in particular between two hydrocarbon rings or as a substituent on a hydrocarbon ring.

A method comprising the dosed addition of the oxidizing agent for the targeted adjustment of an oxygen concentration along a reaction zone in the oxidation reactor, in particular by means of a plurality of oxidizing agent addition points arranged at intervals along the reaction zone, enables a targeted oxidation reaction. For example, oxygen and/or air serve as oxidizing agent. It has been found that liquid compounds, such as hydrogen peroxide, can also serve as oxidizing agent. It is also possible to use an oxidizing agent which is present as a solid, which may in particular be present as a bulk in the oxidation reactor.

In a first embodiment, the oxidation reaction is carried out in the simultaneous presence of the at least partially discharged hydrogen carrier medium and the oxidizing agent in contact with the oxidation catalyst. In particular, the at least partially discharged hydrogen carrier medium and the oxidizing agent are fed together and simultaneously to the oxidation reactor.

In a second embodiment, the addition of the at least partially discharged hydrogen carrier medium and the addition of the oxidizing agent are decoupled in time. The oxidation reaction is carried out in a manner in which, in a first reaction step, only the at least partially discharged hydrogen carrier medium is contacted with the oxidized catalyst in the reaction apparatus and the oxidized form of the catalyst is converted into a reduced form of the catalyst by reaction of the oxygen bound to the catalyst with the at least partially discharged hydrogen carrier medium, with transfer of at least one hydrogen atom to the at least partially discharged hydrogen carrier medium. The catalyst reduced in this manner is then oxidized again in a second reaction step without further addition of the at least partially discharged hydrogen carrier medium but with addition of an oxidizing agent, in particular with addition of air. This second reaction step can be carried out under different or the same temperature and pressure conditions as the first reaction step. In this second embodiment, the first and second reaction step alternate, in particular at regular intervals. The step change occurs at time intervals between 2 seconds and 5 hours, in particular between 10 seconds and 1 hour and in particular between 60 seconds and 30 minutes. The reaction steps can comprise the same or different time periods.

Surprisingly, it has been found that the temporal decoupling of the addition of the at least partially discharged hydrogen carrier medium and the oxidizing agent in this second embodiment leads to an increased selectivity in the oxidation of the at least partially discharged hydrogen carrier medium. In particular, under comparable temperature and pressure conditions, the undesired formation of carbon dioxide is significantly reduced.

The at least partially discharged hydrogen carrier medium and the oxidizing agent are conveyed in the oxidation reactor in particular in countercurrent, i.e. antiparallel to each other. However, it is also conceivable in principle to operate the oxidation reactor in co-current.

It is possible to add the oxidizing agent to the oxidation reactor at several oxidizing agent addition points. The oxidizing agent addition points can be arranged to be spaced apart from each other along the reaction zone in the oxidation reactor. This makes it possible to selectively adjust the oxygen concentration along the reaction zone. By adjusting the oxygen concentration in the oxidation reactor, the oxidation reaction is directly influenced and thus the temperature profile that is established along the reaction zone and thus a heat profile that is available for delivery to the dehydrogenation reactor. By adding the oxidizing agent, it is therefore possible in particular to adjust the temperature profile in the oxidation reactor, in particular to regulate it and in particular to distribute it homogeneously.

Additionally or alternatively, the reaction kinetics in the oxidation reactor can also be carried out by active cooling in the oxidation reactor, in particular along the reaction zone. This makes it possible in particular to regulate the temperature profile along the reaction zone. In particular, exothermic peaks, i.e. temperature excesses, can be suppressed. Active cooling can be performed, for example, by the dosed addition of cold air and/or oxidizing agent which is less heated, in particular in relation to the reaction temperature in the oxidation reactor. The additionally dosed oxidizing agent that is used for active cooling has a maximum temperature of at most 300° C., in particular of at most 200° C., in particular of at most 150° C., in particular of at most 100° C., in particular of at most 50° C. and in particular of at most 30° C.

In particular, it is conceivable that the oxygen concentration in the oxidation reactor is detected by means of at least one sensor, in particular several sensors, which are arranged to be spaced apart from one another along the reaction zone, and in particular that the addition of the oxidizing agent at the oxidizing agent addition points is carried out in a controlled manner. For this purpose, it is possible to arrange controllable valves at the oxidizing agent addition points. The controlled supply of the oxidizing agent can also be carried out with only one oxidizing agent addition point.

In addition or alternatively, the temperature control in the oxidation reactor can also be carried out in that at least partially oxidized hydrogen carrier medium from the oxidation reactor is fed back to the oxidation reactor via a direct return guide in a direct circulation flow, in particular together with the at least partially discharged hydrogen carrier medium H0-LOHC fed to the oxidation reactor. The ratio of the recycled oxidized hydrogen carrier medium Ox-LOHC to the at least partially discharged hydrogen carrier medium H0-LOHC allows the temperature profile in the oxidation reactor to be regulated, in particular to be distributed more homogeneously, since partial conversions take place per reaction section. In particular, it is thus possible to avoid local and/or temporal exothermic peaks that can cause thermal degradation of the hydrogen carrier medium. The risk of premature degradation of the hydrogen carrier medium can be influenced by the targeted temperature and is reduced, i.e. decreased, in the oxidation reactor by the targeted addition of oxidizing agent and/or recirculation of the at least partially oxidized hydrogen carrier medium Ox-LOHC.

A method comprising, in particular thermal, utilization of the oxidizing agent discharged from the oxidation reactor in a thermal utilization unit increases its overall efficiency. In particular, the demand for external heat is reduced. In particular, it has been found that the oxidizing agent that is discharged from the oxidation reactor can advantageously be thermally utilized. For this purpose, it may be advantageous to sever the oxidizing agent from a mixture that is discharged from the oxidation reactor prior to thermal utilization.

A method, in which the proportion of by-products, in particular high-boiling by-products with more than three linked aromatic ring systems by polymerization and/or condensation reactions, and/or cleavage products, in particular toluene, xylene and/or benzene, in the H0-LOHC after dehydrogenation is at most 3%, in particular at most 1% and in particular at most 0.3%, ensures a reduced, i.e. decreased, proportion of, in particular undesirable, by-products in the cycle of the hydrogen carrier medium. In particular, the proportion of polyaromatic hydrocarbons and/or cleavage products such as toluene and/or benzene after dehydrogenation is at most 3% by weight, in particular at most 1% by weight and in particular at most 0.3% by weight.

The use of a hydrogen carrier medium, in which aromatic hydrocarbons, in particular their hydrogenated form, in particular with a methylene functional group, in particular a mixture of biphenyl and diphenylmethane, in particular with a ratio of 40:60, in particular 35:65 and in particular 30:70, serve as Hx-LOHC, is advantageous. In particular, the hydrogen carrier medium has aromatic hydrocarbons with a methylene functional group. A mixture of diphenylmethane and biphenyl has been found to be particularly suitable. Biphenyl has been found to serve as a eutectic additive and to lower the melting point of the mixture to below 20° C. In addition, biphenyl has a high hydrogen storage capacity, which is 7.2% by weight. Diphenylmethane is particularly suitable for the oxidation reaction, since only methylene functional groups are present, which are selectively reacted, i.e. selectively oxidized. The degredation of this mixture in the form of oxygen-containing by-products is reduced, i.e. decreased. A mixture of biphenyl and diphenylmethane in a ratio of 40:60, in particular 35:65 and in particular 30:70 has proven to be particularly advantageous.

Additionally or alternatively, the hydrogen carrier medium may comprise benzyltoluene and/or dibenzyltoluene.

A method, in which the reaction temperature during oxidation is greater than the reaction temperature during dehydrogenation, wherein in particular Tₒₓ≥10° K+T_{de}, in particular Tₒₓ≥20° K+T_{de}, in particular Tₒₓ≥30° K+T_{de} and in particular Tₒₓ≥50° K+T_{de}, reduces the additional heat demand for the dehydrogenation reaction. It has been recognized that the transfer of heat to the dehydrogenation reaction is advantageous when the reaction temperature in the oxidation reactor is at least 10° K greater than the reaction temperature in the dehydrogenation reactor. The heat transfer can be carried out, for example, by means of a thermal oil circuit. Additionally or alternatively, it is conceivable to integrate the oxidation reactor structurally, i.e. constructively, in and/or on the dehydrogenation reactor. A direct heat transfer is thus simplified. For the integration of the oxidation reactor into the dehydrogenation reactor, a high-volume design is particularly suitable, in particular by means of a plurality of oxidation tubes, in order to improve the heat transfer.

A method, in which the hydrogen gas released by the dehydrogenation has a content of the at least one oxygen-containing impurity which is less than 200 ppmV, in particular less than 100 ppmV, in particular less than 10 ppmV and in particular less than 1 ppmV, enables the provision of hydrogen gas with increased purity.

A system according to the invention has substantially the advantages of the method according to the invention, to which reference is hereby made. In particular, it has been found that a system comprising a dehydrogenation reactor, an oxidation reactor, a hydrogenation reactor and a purification unit enables a particularly efficient release process and the purity of the released hydrogen gas is improved.

A system, in which the purification unit (23) is designed as an adsorption unit, has proven to be particularly efficient. The removal of the oxygen-containing impurities from the hydrogen carrier material is particularly efficient by means of an adsorption unit. Additionally or alternatively, a water separator and/or a stripping column can also serve as a purification unit.

A system, in which the oxidation reactor has at least one oxidizing agent addition point, in particular a plurality of oxidizing agent addition points arranged to be spaced apart along a reaction zone in the oxidation reactor, for selectively adjusting an oxygen concentration along the reaction zone, simplifies the targeted feed of an oxidizing agent into the oxidation reactor. In particular, controllable valves are arranged at the at least one oxidizing agent addition point, which valves are in signal connection, in particular bidirectional signal connection, with a regulating unit.

An embodiment of the system, in which the oxidation reactor is at least partially integrated in the dehydrogenation reactor, wherein in particular the oxidation reactor has at least one oxidation tube in which the oxidation reaction takes place, wherein the at least one oxidation tube is arranged, in particular completely, inside the dehydrogenation reactor, is particularly efficient with regard to heat transfer from the oxidation reactor to the dehydrogenation reactor. A direct, in particular immediate, heat transfer to the dehydrogenation reactor is thereby improved. Heat transfer losses are minimized. In particular, the proportion of the heat generated in the oxidation reactor to the dehydrogenation reactor is at least 80%, in particular at least 90%, in particular at least 95%, in particular at least 98% and in particular 100%.

A system in which the oxidation reactor has at least one oxidation tube in which the oxidation reaction takes place, wherein the at least one oxidation tube is arranged, in particular completely, within the dehydrogenation reactor, has a high-volume oxidation reactor. The heat transfer is thereby improved. It is particularly advantageous if the oxidation reactor is arranged by at least 60%, by at least 70%, in particular by at least 80%, in particular by at least 90% and in particular completely, within the dehydrogenation reactor. A fully integrated arrangement is understood to mean that at least the part of the oxidation reactor in which the oxidation reaction takes place is arranged completely within an installation space of the dehydrogenation reactor. The installation space of the dehydrogenation reactor is understood to mean the part of the dehydrogenation reactor in which the dehydrogenation reaction takes place. This means in particular that complete integration of the oxidation reactor into the dehydrogenation reactor is also given if individual components of the reactors, such as feed lines and connections, are arranged outside the reaction space of the respective other reactor.

It is particularly advantageous if the at least one oxidation tube is at least partially and in particular completely surrounded by the dehydrogenation catalyst, wherein the flow direction of the at least partially charged hydrogen carrier medium through the dehydrogenation reactor is arranged transversely and in particular perpendicularly to the longitudinal axis of the at least one oxidation tube.

A system, in which the oxidation reactor comprises a plurality of oxidation tubes which are arranged in series, in particular along a fluid flow direction through the oxidation reactor, wherein in particular at least one oxidizing agent addition point is arranged at the transition between two oxidation tubes arranged in series, enables advantageous integration of multiple oxidizing agent addition points into the oxidation reactor.

Both the features indicated in the method and the system according to the invention and the features given in the embodiment example of a system according to the invention are each suitable, alone or in combination with each other, for further embodying the subject-matter according to the invention. The respective combinations of features do not represent any restrictions with regard to the further embodiments of the subject-matter of the invention, but are essentially merely exemplary in character.

Further features, advantages and details of the invention will be apparent from the following description of an embodiment example based on the drawing.

### BRIEF DESCRIPTION OF THE PREFERRED EMBODIMENT

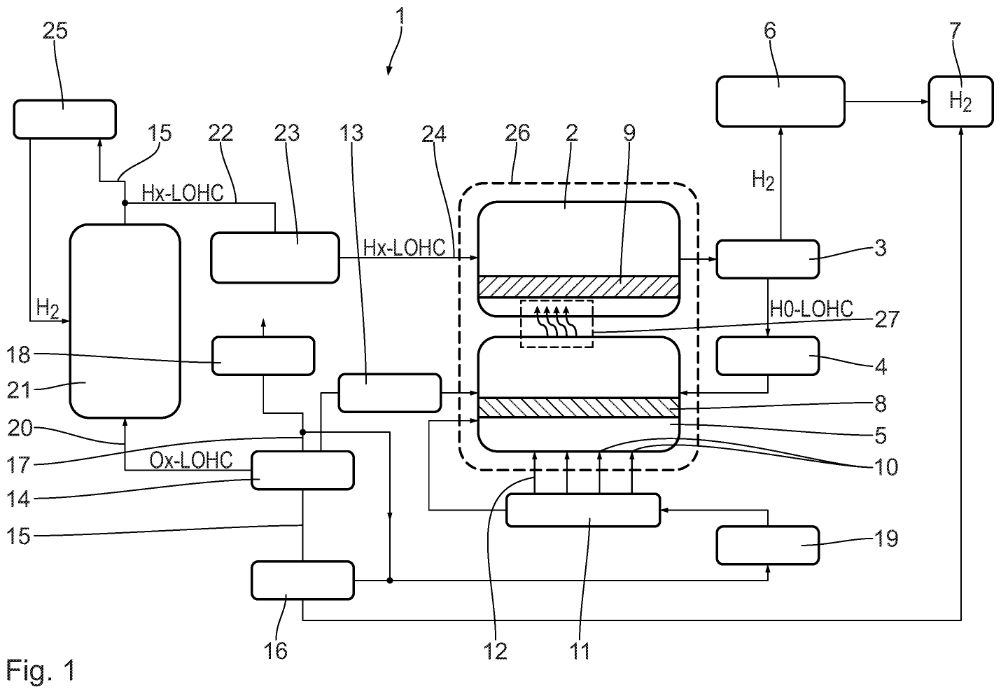

FIG. 1 shows a schematic representation of a system according to the invention,

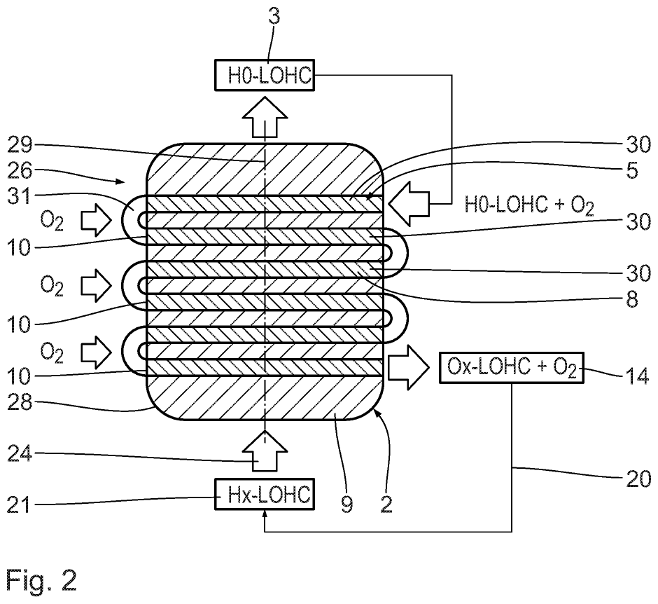

FIG. 2 shows a schematic representation of an oxidation reactor that is integrated in a dehydrogenation reactor.

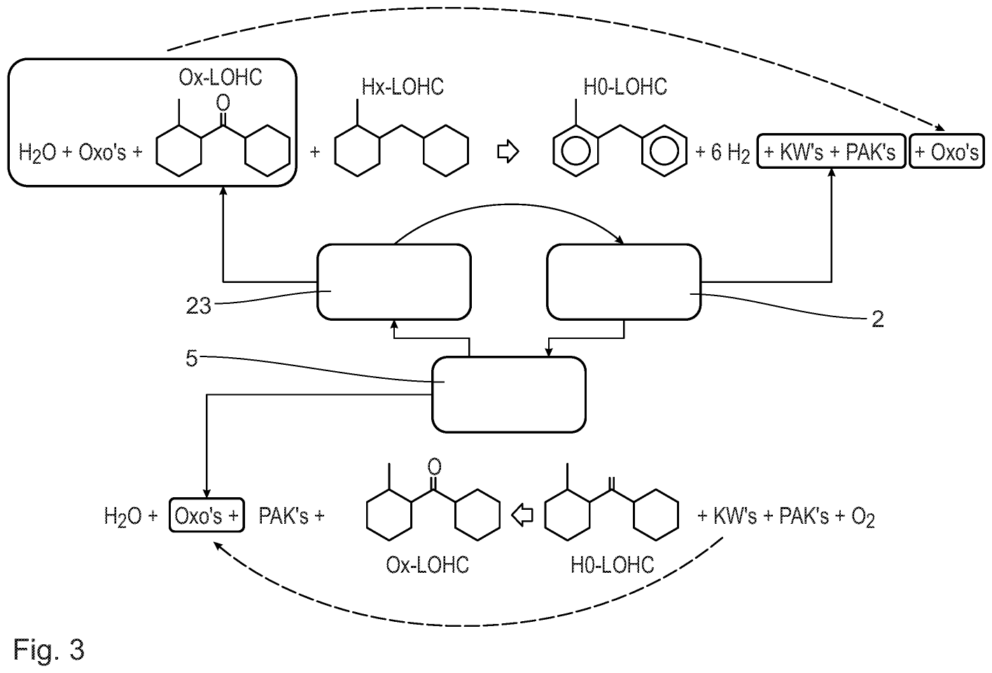

FIG. 3 shows a schematic representation of the reactions in the system according to FIG. 1,

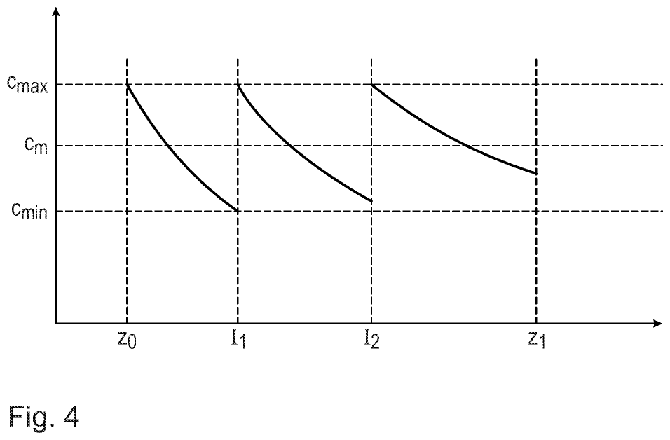

FIG. 4 shows a schematic representation of the functional relationship of the oxygen concentration in the oxidation reactor according to FIG. 2.

### DESCRIPTION OF THE PREFERRED EMBODIMENT

A system marked 1 in FIG. 1 as a whole is used to provide hydrogen gas, in particular with increased purity.

The system 1 has a dehydrogenation reactor 2 in which a dehydrogenation catalyst 9 is arranged. The dehydrogenation catalyst 9 has a metallic catalyst material which is sulphidized.

A first separation apparatus 3 is connected to the dehydrogenation catalyst 2, which separation apparatus 3 serves to sever hydrogen gas from the hydrogen carrier medium that is discharged from the dehydrogenation reactor 2 in the at least partially discharged form (H0-LOHC).

The first separation apparatus 3 is connected to a gas purification unit 6, which can be coupled to a hydrogen gas utilization unit 7. The hydrogen utilization unit 7 is in particular a fuel cell.

A first recuperation apparatus 4 is connected to the first separation apparatus 3, which recuperation apparatus 4 is connected to an oxidation reactor 5. An oxidation catalyst 8 is arranged in the oxidation reactor 5.

The oxidation catalyst 8 is arranged in the oxidation reactor 5 along a reaction zone. The reaction zone in the oxidation reactor is defined by the flow of the at least partially discharged hydrogen carrier medium H0-LOHC through the oxidation reactor 5. According to FIG. 1, the reaction zone is oriented from right to left, i.e. from the inflow opening for the at least partially discharged hydrogen carrier medium H0-LOHC to the outflow opening.

The oxidation reactor 5 has a plurality of oxidizing agent addition points 10 at which oxidizing agent can be added to the oxidation reactor 5 separately and in particular independently of one another. The oxidizing agent addition points 10 are arranged at a distance from one another along the reaction zone. In particular, the oxidizing agent addition points are arranged one behind the other along a fluid direction through the reaction zone.

A dosing unit 11 is connected to the oxidation reactor 5 for the dosed addition of the oxidizing agent. The dosing unit 11 has a plurality of feed lines 12 via which oxidizing agent can be added to the oxidation reactor 5. Each feed line 12 is connected to an oxidizing agent addition point 10. The feed lines 12 can have valves, in particular controllable valves, in order to ensure a controlled addition of the oxidizing agent into the oxidation reactor 5.

A second recuperation apparatus 13 is connected to the oxidation reactor 5, in which heat recovery of a mixture that has been discharged from the oxidation reactor 5 takes place. The second recuperation apparatus 13 is connected to a second separation apparatus 14. The second separation apparatus 14 is used to separate gaseous and liquid components and in particular to sever water. The second separation apparatus is connected to an electrolyzer 16 via a water line 15. The electrolyzer 16 can be coupled to the hydrogen gas utilization unit 7.

A thermal utilization unit 18 is connected to the second separation apparatus 14 via a gas line 17. In addition, the gas line 17 has a branch line via which the second separation apparatus 14 is connected to the dosing unit 11. In particular, a third recuperation apparatus 19 is arranged along the branch line. The third recuperation apparatus 19 serves in particular to preheat the oxygen-containing mixture as an oxidizing agent.

It is conceivable that the oxygen-containing mixture is directly thermally utilized in the thermal utilization unit 18. In addition or alternatively, the gas line 17 and the third recuperation apparatus 19 enable a circulation flow for the oxygen-containing gas mixture. With a circulation flow for the oxygen-containing gas mixture, the heat demand for preheating in the third recuperation apparatus 19 is reduced. At most, only minor heating and/or no heating is required. The provision of the oxidizing agent in the dosing unit 11 is thus simplified.

The electrolyzer 16 may be connected to the dosing unit 11 by means of an oxygen line, in particular via the third recuperation apparatus 19.

The second separation apparatus 14 is connected to a hydrogenation reactor 21 via a hydrogen carrier medium line 20. The hydrogenation reactor 21 is connected to a purification unit 23 via a fluid line 22. According to the embodiment example shown, the purification unit 23 is designed as an adsorption unit. The purification unit 23 is connected to the dehydrogenation reactor 2 via a feed line 24.

The hydrogenation reactor 21 is connected to a second electrolyzer 25 by means of another water line 15. It is also possible that the hydrogenation reactor 21 is connected to the electrolyzer 16. The system expenditure is thereby reduced. The hydrogen gas produced in the electrolyzer can be fed to the hydrogen gas utilization unit 7 and/or to the hydrogenation reactor 21. The oxygen gas that is generated in the electrolyzer 25 can be delivered to the environment and/or to the dosing unit 11.

According to the embodiment example shown, the dehydrogenation reactor 2 and the oxidation reactor 5 are combined and in particular integrated into each other. The dehydrogenation reactor 2 and the oxidation reactor 5 form a combination reactor 26, which is shown purely schematically in FIG. 1. The design of the combination reactor 26 improves heat transfer from the oxidation reactor 5 to the dehydrogenation reactor 2, in particular heat losses during heat transfer are reduced.

The heat transfer can be carried out in particular by means of a separate heat transfer unit 27, in particular by means of a thermal oil circuit. The heat transfer unit 27 is indicated in FIG. 1 purely symbolically by the heat transfer arrows.

With reference to FIG. 2, an embodiment example of the combination reactor 26 is explained in more detail below. The dehydrogenation reactor 2 has an outer housing 28 in which the dehydrogenation catalyst 9 is arranged. The housing 28 has a longitudinal axis 29 which, according to the embodiment example shown, is oriented vertically. The longitudinal axis 29 can be inclined with respect to the vertical and in particular can also be arranged perpendicularly thereto, i.e. horizontally. According to FIG. 2, the feed line 24 is connected to the dehydrogenation reactor 2 at an underside. The feed line 24 serves to feed at least partially charged hydrogen carrier medium (Hx-LOHC) which has been hydrogenated in the hydrogenation reactor 21, i.e. charged with hydrogen. Hx-LOHC flows upwards in the dehydrogenation reactor 2 along the longitudinal axis 29. The longitudinal axis 29 determines the flow direction for the medium in the dehydrogenation reactor 2.

A plurality of oxidation tubes 30 of the oxidation reactor 5 are arranged transversely and in particular perpendicularly to the longitudinal axis 29 in the housing 28. The oxidation tubes 30 are oriented horizontally according to the embodiment example shown.

The oxidation catalyst 8 is arranged in the oxidation tubes 30.

The oxidation tubes 30 are arranged one behind the other along a fluid flow direction through the oxidation reactor 5 and are connected to each other by connecting tubes 31. The connecting tubes 31 are designed in such a manner that one end of each oxidation tube 30 is connected to the beginning of a subsequent oxidation tube 30. The connecting tubes 31 are U-shaped. The interconnected oxidation tubes 30 form a meandering oxidation line. The oxidizing agent addition points 10 are arranged in each case at the transition between 2 oxidation tubes 30 arranged in series, in particular in the region of the connecting tubes 31.

The oxidation tubes 30 are embedded in the housing 28, in particular in the dehydrogenation catalyst 9, and are in particular completely, i.e. fully circumferentially, surrounded by the dehydrogenation catalyst 9.

The oxidation tubes 30 are arranged entirely within the housing 28 of the dehydrogenation reactor 2. The oxidation reactor 5 is formed by the entirety of the oxidation tubes 30. This means that the oxidation reactor 5 is integrated in the dehydrogenation reactor 2. In this embodiment, the heat transfer unit 27 is formed by the oxidation reactor 5, in particular the oxidation tubes 30, and the dehydrogenation reactor 2, in particular the dehydrogenation catalyst 9. Separate components are dispensable for the heat transfer unit 27. The heat transfer unit 27 is of integrated design. This design is particularly space-saving and compact. This embodiment of the heat transfer unit 27 is uncomplicated and cost-efficient.

At one end of the meandering oxidation line, the second separation apparatus 14 is connected to the oxidation reactor 5, which is connected to the hydrogenation reactor 21.

It is possible to design the oxidation tubes 30 with a start-up section. In the region of the start-up section, the oxidation tubes 30 are arranged in particular outside the housing 28 of the dehydrogenation reactor 22 and in particular are not embedded in the dehydrogenation catalyst 9. This means in particular that the oxidation tubes 30 are embedded in the dehydrogenation catalyst 9 in some regions. It is conceivable, for example, that the oxidation tubes 30 are embedded in the dehydrogenation catalyst 9 only regionally with respect to their respective tube length. It is additionally or alternatively possible that at least one oxidation tube 30 is not or at least not completely embedded in the dehydrogenation catalyst 9. Nevertheless, other oxidation tubes may be fully embedded in the dehydrogenation catalyst 9.

The start-up section for the oxidation reaction makes it possible, in particular, for the oxidation heat in the region of the start-up section to be used for heating and setting the temperature level to that of the dehydrogenation.

The method for providing hydrogen gas by means of the system 1 is explained in more detail below.

The at least partially charged hydrogen carrier medium Hx-LOHC, which according to the embodiment example shown is formed as a 30:70 mixture of biphenyl and diphenylmethane, is fed to the dehydrogenation reactor 2 and at least partially dehydrogenated in the dehydrogenation reactor 2 by contact with the dehydrogenation catalyst 9. For the endothermic dehydrogenation reaction, heat is provided from the oxidation reactor 5 by means of the heat transfer unit 27.

From the dehydrogenation reactor 2, a mixture which contains released hydrogen gas and H0-LOHC is fed to the first separation apparatus 3. In the first separation apparatus, gaseous components in particular are severed from the liquid H0-LOHC and fed to the gas purification unit 6. In addition to the released hydrogen gas H2, the gas stream supplied to the gas purification unit 6 has gaseous impurities, in particular hydrocarbons, which are in particular at most 1000 ppmV. In addition, the gas stream may have minor proportions of oxygen-containing impurities which are at most 200 ppmV. The gaseous impurities, i.e. the hydrocarbons and the oxygen-containing impurities, are separated in the gas purification unit 6. The hydrogen provided by the gas purification unit 6 to the hydrogen gas utilization unit 7 has a purity of at least 99%.

The H0-LOHC severed in the first separation apparatus 3 passes through the first recuperation apparatus 4 and is fed to the oxidation reactor 5. The first recuperation apparatus 4 can also be arranged upstream of the first separation apparatus 3, i.e. between the dehydrogenation reactor 2 and the first separation apparatus 3. It is also conceivable to arrange the first recuperation apparatus 4 integrated in the first separation apparatus 3. In the integrated arrangement, the hot heat flows of the hydrogen gas and/or the H0-LOHC can be efficiently and in particular simultaneously separated from each other and dissipate heat to the colder material streams.

As a result of the fact that selective dehydrogenation has taken place in the dehydrogenation reactor 2, LOHC cleavage products and/or high-boiling by-products, which are less readily utilizable oxidatively, are reduced, i.e. decreased, in the material stream that is fed to the oxidation reactor 5. The LOHC cleavage products and the high-boiling by-products lead to a reduction in heat release and are therefore undesirable. By reducing them, undesirable oxidations can be prevented, which lead to an undesirable increase in the oxygen-containing impurities in the material stream. By avoiding oxygen-containing impurities in the hydrogen carrier medium, the proportion of oxygen-containing impurities in the released hydrogen gas is reduced, i.e. decreased. The downstream purification in the gas purification unit 6 is thus possible with reduced effort.

In the oxidation reactor 5, the selective oxidation of the H0-LOHC, in particular of alkyl functional groups and/or alkylene groups, in particular R—CH₃ or R₁-CH₂-R₂ takes place.

Performing the oxidation reaction in the oxidation reactor 5 requires the supply of an oxidizing agent, in particular oxygen or air, in particular with the dosing unit 11. The oxidation reaction is exothermic. The heat generated in the process is transferred at least proportionally and in particular completely from the oxidation reactor 5 to the dehydrogenation reactor 2. The heat transfer unit 27 is used for the heat transfer.

It has been recognized that the reaction conditions in the oxidation reactor 5, i.e. the oxidation conditions, are improved by the fact that the oxidizing agent can be added at different locations along the reaction zone. The oxidizing agent addition points 10 serve this purpose. It is thereby possible in particular to adjust the oxygen concentration along the reaction zone in a targeted manner. It has been found that the control of the oxygen concentration is in particular directly related to the conversion and in particular to the selectivity of the oxidation of the H0-LOHC. Investigations have shown that an essentially homogeneous distribution of the oxygen concentration along the reaction zone is advantageous.

FIG. 4 shows an example of the functional relationship of the oxygen concentration c across the reaction zone. The reaction zone begins at z₀ and ends at z₁, wherein two oxidizing agent addition points 10 are schematically shown in FIG. 4 as I₁ and I₂. The oxygen concentration in the reaction zone has a maximum value cₘₐₓ at the beginning of the reaction zone z₀, wherein the oxygen concentration then decreases exponentially up to the first oxidizing agent addition point I₁. There, the oxygen concentration is increased again to the maximum value cₘₐₓ by the oxidizing agent addition point I₁, followed by a renewed exponential decrease to the second oxidizing agent addition point I₂, where an increase to the maximum value cₘₐₓ occurs again. This results in a mean value for the oxygen concentration cm, which is also shown in FIG. 4. A homogeneous distribution of the concentration profile along the reaction zone is therefore understood to mean that the value of the oxygen concentration moves within a tolerance range around the mean value cm, wherein the tolerance range is defined by the maximum value cₘₐₓ and the minimum value cₘᵢₙ. A homogeneous distribution of the concentration profile is present in particular if the maximum value cₘₐₓ is between 110% and 150%, in particular between 115% and 140% and in particular between 120% and 130% of the mean value cm and the minimum value cₘᵢₙ is between 0.5 and 0.9 of the mean value, in particular between 0.6 and 0.85 and in particular between 0.65 and 0.75 of the mean value.

It has been found that the oxygen concentration c can be decisive for the selectivity of the oxidation reaction and in particular for the desired, selective conversion of alkylene functional groups. It is advantageous if the initial oxygen concentration, i.e. at the beginning of the reaction zone, assumes a high value. This results in a high productivity of the oxidation reaction. However, high productivity also means increased by-product formation. A low initial oxygen concentration leads to a higher selectivity. The selective dosed addition of oxygen along the reaction zone can therefore increase the overall productivity, i.e. the average oxygen concentration Cm, while at the same time reducing the initial concentration cₘₐₓ, in particular compared to a single oxygen addition with an exponential decrease of the oxygen concentration across the reaction zone. In particular, the productivity of the oxidation reaction can be increased due to the higher average concentration cm. Due to the increased conversion in the oxidation reaction, increased reaction exotherm, i.e. increased generation of heat that can be provided for the dehydrogenation reaction, follows. In particular, it has been found that the more uniform oxygen concentration provided by the plurality of oxidizing agent addition points 10 results in a more uniform release of reaction heat along the reaction zone. In addition, targeted temperature control along the reaction zone is possible.

The heat released by the oxidation reaction in the oxidation reactor 5 is supplied to the dehydrogenation in the dehydrogenation reactor 2. For this purpose, the oxidation reactor 5 can be integrated into the dehydrogenation reactor 2, as shown in FIG. 2. In the integrated embodiment, a high-volume oxidation reactor 5 comprising a plurality of oxidation tubes 30 is particularly advantageous, wherein the flow direction through the oxidation reactor 5 is in particular countercurrent or, as shown in FIG. 2, crosscurrent with respect to the fluid flow direction through the dehydrogenation reactor 2. It is advantageous if the reaction temperature in the oxidation reactor is at least 10° K, in particular at least 20° K, in particular at least 30° K and in particular at least 50° K above the reaction temperature of the dehydrogenation reactor.

Following the oxidation reaction in the oxidation reactor 5, the material streams are separated from each other in the at least second separation apparatus 14 and recuperated in the second recuperation apparatus 13, i.e. heat is recovered, in particular for pre-heating other material streams. As with the first recuperation apparatus 4 and the first separation apparatus 3, the sequence of the second recuperation apparatus 13 and the second separation apparatus 14 can also be selected differently. In particular, the second recuperation apparatus 13 can be integrated in the second separation apparatus 14. In the second separation apparatus 14, in particular the liquid components, in particular water and at least partially oxidized hydrogen carrier medium Ox-LOHC, are separated from the gaseous components, in particular air and in particular oxygen. In the process, impurities and by-products may still be present in the separated material streams at most 5%, in particular at most 3%, in particular at most 1% and in particular at most 1000 ppmV. In the oxidation reactor 5, water is formed as a by-product to be at least equimolar. It is particularly advantageous if water is separated from the Ox-LOHC in the second separation apparatus 14, purified and disposed of.

Water formed in the oxidation reactor 5 can additionally or alternatively be made available to the electrolyzer 16 by means of the water line 15. In the electrolyzer 16, the water is separated into its components, wherein the released hydrogen gas can be made available to the hydrogen gas utilization unit 7. The released oxygen gas can be recycled to the dosing unit 11. Surprisingly, it has been found that the severed water can be advantageously used for electrolysis. The energy demand required for electrolysis can be at least partially covered by external energy addition and/or energetic coupling with the exothermic oxidation reaction.

The gas fraction separated in the second separation apparatus 14, in particular oxygen, in particular air, can be thermally utilized with fractions of carbon compounds in the thermal utilization unit 18. The released heat can, for example, be made available to the dehydrogenation reactor 2. In particular, it is also conceivable to discharge the severed gas stream directly to the environment if carbon compounds of toxic concern, such as benzene, are still purified by means of a purification unit not shown separately. However, the severed gas stream from the second separation apparatus 14 can also be made available for the oxidation reaction of the dosing unit 11.

The fraction of Ox-LOHC severed from water is fed to the dehydrogenation reactor 21 for hydrogenation. It is advantageous if the hydrogenation reactor 21 and the dehydrogenation reactor 2 are arranged at different, in particular spatially distant locations. The hydrogenation reactor 21 is arranged in particular at an energy-rich location, i.e. where there is an energy surplus and in particular where energy is available at comparatively favourable conditions. The dehydrogenation reactor 2 is arranged in particular at a low-energy location, i.e. where there is a demand for energy and energy is available in particular at cost-intensive conditions. The transport of the hydrogen carrier medium Hx-LOHC from the high-energy location to the low-energy location and the transport of the oxidized hydrogen carrier medium Ox-LOHC from the low-energy location to the high-energy location can be carried out using suitable transport vehicles such as tank trucks, ships and/or trains, but also by means of a pipeline provided for this purpose.

In particular, it has been found that the transport of the Ox-LOHC is possible in an uncomplicated manner because Ox-LOHC is substantially saturated with oxygen-containing impurities, in particular water, oxygen-containing carbon compounds and/or physically dissolved gases. In particular, there is no need to transport under safety-relevant controlled conditions. The transport is thus simplified. Further contamination with air, oxygen or water is unlikely. In particular, a costly securing of the Ox-LOHC, in particular in the form of an inert gas blanketing, in particular by means of nitrogen, is not necessary or less relevant with regard to existing impurities that will be removed at a later time anyway.

It has been found in particular that water, which has been formed in particular during the oxidation of the LOHC, can be transported together with the oxidized hydrogen carrier medium Ox-LOHC to the energy-rich location. The transport takes place in particular in a tank truck. The same volume is sufficient for the transport of the Ox-LOHC with the water as for the transport of the discharged hydrogen carrier medium H0-LOHC. It has thus been found that despite the formation of water, no additional transport effort is required if the water is transported to the energy-rich location, i.e. in particular no further use and/or treatment of the water takes place at the energy-poor location. The transport of the water to the high-energy location is unproblematic and, in particular, does not involve any additional effort insofar as a separation of water and the hydrogen carrier medium takes place at the high-energy location anyway, since water is formed during the reduction of oxidized hydrogen carrier medium Ox-LOHC.

Advantageously, after the hydrogenation reaction in the hydrogenation reactor 2, oxygen contamination of the Hx-LOHC is avoided to prevent the introduction of oxygen-containing compounds into the dehydrogenation reactor 2.

Ox-LOHC is added to the hydrogenation reactor 21 and chemically reduced by means of hydrogen gas H₂. In the process, Ox-LOHC is converted into Hx-LOHC with the release of heat. Oxygen-containing impurities are also converted with the release of heat. During the chemical reduction of the functional, oxygen-containing groups, water is produced to be equimolar.

In the purification unit 23, which is downstream of the hydrogenation catalyst 21, Hx-LOHC is conditioned and in particular severed from oxygen-containing impurities, in particular unreacted oxygen-containing carbon compounds, in particular Ox-LOHC and/or further oxidized carbon compounds and/or water. In particular, dissolved oxygen-containing gases are also severed from the Hx-LOHC in the purification unit 23. Surprisingly, it has been found that the efficient removal of the oxygen-containing impurities in the Hx-LOHC after hydrogenation can be realized, in particular by a purification unit in the form of a separator for water impurities, a stripping column and/or an adsorptive filter stage. The purification of these impurities is possible in an uncomplicated manner. The effort required for purification is reduced. As a result, Hx-LOHC is provided for the subsequent hydrogenation in the hydrogenation unit 21 with a purity that makes subsequent conditioning of the released hydrogen gas, in particular with regard to oxygen-containing impurities, simplified and, in particular, insignificant.

It is conceivable to provide, in addition or as an alternative to the purification unit 23, a further purification unit for removing oxygen-containing impurities, in particular at the high-energy location, which is arranged upstream of the hydrogenation reactor 21. In the upstream purification unit, a selective removal of oxygen-containing impurities takes place. In particular, the upstream purification unit enables protection of the hydrogenation catalyst in the hydrogenation reactor 21.

It is also conceivable to provide a purification unit at the low-energy location immediately upstream of the dehydrogenation reactor 2.

The water severed by means of the purification unit 23 can be fed to the electrolyzer 25 or the electrolyzer 16 for splitting.

FIG. 3 shows the material streams formed or converted in the relevant units, i.e. in the dehydrogenation reactor 2, the oxidation reactor 5 and the purification unit 23. From this it can be seen that in the dehydrogenation reactor 2, by means of the sulphidized dehydrogenation catalyst 9, the at least partially charged hydrogen carrier medium Hx-LOHC is dehydrogenated to form the at least partially discharged hydrogen carrier medium H0-LOHC with hydrogen release. In addition, hydrocarbons (HCs) such as toluene and/or cyclohexane, polyaromatic hydrocarbons (PAHs) such as naphthalene and/or anthracene, as well as oxidized carbons (oxos), in particular oxocarbons, which consist exclusively of carbon and oxygen, such as carbon monoxide (CO) and carbon dioxide (CO₂), and in particular oxidized hydrocarbons, such as benzaldehyde, are contained in the material stream that is discharged from the dehydrogenation reactor 2. In particular, the proportion of oxos is substantially dependent on the preceding adsorptive purification in the purification unit 23. As a result of the fact that the proportion of water, oxos and/or Ox-LOHC is reduced, i.e. decreased, in the purification unit 23, the proportion of oxos in the material mixture discharged by the dehydrogenation reactor 2 is also reduced, i.e. decreased.

During the oxidation reaction in the oxidation reactor 5 by means of the oxygen dosage, H0-LOHC is converted into Ox-LOHC, in particular with the formation of water and oxos, which are chemically reduced.

1. A method for providing hydrogen gas comprising the method steps of:
releasing of hydrogen gas (H2) in a dehydrogenation reactor by catalytic dehydrogenation of an at least partially charged hydrogen carrier medium to form an at least partially discharged hydrogen carrier medium;
catalytic oxidation of the at least partially discharged hydrogen carrier medium by means of an oxidizing agent to form an at least partially oxidized hydrogen carrier medium in an oxidation reactor;
reduction of the at least partially oxidized hydrogen carrier medium to form the at least partially charged hydrogen carrier medium by catalytic hydrogenation in a hydro-genation reactor; and
removal of at least one oxygen-containing impurity at least one of from the at least partially charged hydrogen carrier medium and from the at least partially oxidized hydrogen carrier medium.

2. The method according to claim 1, wherein transferring heat generated in the oxidation reactor to the dehydrogenation reactor.

3. The method according to claim 1, comprising the use of a dehydrogenation catalyst further comprising a metallic catalyst material.

4. The method according to claim 1, that wherein the catalytic oxidation comprises selectively oxidizing at least one of an alkyl functional group and/or an alkylene functional group of the at least partially discharged hydrogen carrier medium.

5. The method according to claim 1, characterized by comprising the dosed addition of the oxidizing agent for the targeted adjustment of an oxygen concentration along a reaction zone in the oxidation reactor, in particular by means of a plurality of oxidizing agent addition points arranged at intervals along the reaction zone.

6. The method according to claim 1, comprising thermal utilization of the oxidizing agent discharged from the oxidation reactor in a thermal utilization unit.

7. The method according to claim 1, wherein at least one of the proportion of by-products and/or cleavage products in the H0-LOHC after dehydrogenation is at most 3%.

8. The method according to claim 1, wherein aromatic hydrocarbons serve as Hx-LOHC.

9. The method according to claim 1, wherein the reaction temperature during oxidation is greater than the reaction temperature during dehydrogenation, wherein Tₒₓ≥10° K.+T_{de}.

10. The method according to claim 1, wherein the hydrogen gas released by the dehydrogenation has a content of the at least one oxygen-containing impurity which is less than 200 ppmV.

11. A system for providing hydrogen gas comprising:
a dehydrogenation reactor for releasing hydrogen gas by catalytic dehydrogenation of an at least partially charged hydrogen carrier medium by means of a dehydrogenation catalyst into at least partially discharged hydrogen carrier medium;
an oxidation reactor for catalytically oxidizing the at least partially discharged hydrogen carrier medium by means of an oxidizing agent to an at least partially oxidized hydrogen carrier medium;
a hydrogenation reactor for reducing the at least partially oxidized hydrogen carrier medium to the at least partially charged hydrogen carrier medium by catalytic hydrogenation; and
a purification unit for removing at least one oxygen-containing impurity at least one of from the at least partially charged hydrogen carrier medium and from the at least partially oxidized hydrogen carrier medium.

12. The system according to claim 11, wherein the purification unit is designed as an adsorption unit.

13. The system according to claim 11, wherein the oxidation reactor has at least one oxidizing agent addition point.

14. The system according to claim 11, wherein the oxidation reactor is at least partially integrated in the dehydrogenation reactor, wherein in particular the oxidation reactor has at least one oxidation tube in which the oxidation reaction takes place, wherein the at least one oxidation tube is arranged, in particular completely, inside the dehydrogenation reactor.

15. The system according to claim 14, wherein the oxidation reactor comprises a plurality of oxidation tubes which are arranged in series.

16. The method according to claim 3, wherein the metallic catalyst material is in particular sulphidized.

17. The method according to claim 1, comprising the dosed addition of the oxidizing agent for the targeted adjustment of an oxygen concentration along a reaction zone in the oxidation reactor by means of a plurality of oxidizing agent addition points arranged at intervals along the reaction zone.

18. The method according to claim 9, wherein the by-products are high-boiling by-products with more than three linked aromatic ring systems by at least one of polymerization and condensation reactions.

19. The system according to claim 11, wherein a mixture of biphenyl and diphenylmethane serves as Hx-LOHC.

20. The system according to claim 12, wherein the mixture of biphenyl and diphenylmethane has a ratio between 40:60 and 30:70.

21. The system according to claim 13, wherein the oxidation reactor has a plurality of oxidizing agent addition points arranged to be spaced apart along a reaction zone in the oxidation reactor, for selectively adjusting an oxygen concentration along the reaction zone.

22. The system according to claim 14, wherein the oxidation reactor has at least one oxidation tube in which the oxidation reaction takes place.

23. The system according to claim 22, wherein the at least one oxidation tube is arranged inside the dehydrogenation reactor.

24. The system according to claim 23, wherein the at least one oxidizing agent addition point is arranged at the transition between two oxidation tubes arranged in series.
